(19) United States
(12) Patent Application Publication
(10) Pub. No.: US 2011/0032347 A1
(43) Pub. Date: Feb. 10, 2011

(54) ENDOSCOPY SYSTEM WITH MOTION SENSORS

(76) Inventors: Gerard Lacey, County Wicklow (IE); Fernando Vilarino, Dublin (IE)

Correspondence Address: JACOBSON HOLMAN PLLC, 400 SEVENTH STREET N.W., SUITE 600, WASHINGTON, DC, 20004, US

(21) Appl. No.: 12/736,536

(22) PCT Filed: Apr. 15, 2009
(86) PCT No.: PCT/IE2009/000018

§ 371 Date: Oct. 15, 2010

(30) Foreign Application Priority Data
Apr. 15, 2008 (IE) 2008/0281

(51) Int. Cl. H04N 7/18

(52) U.S. Cl. 348/68; 348/65; 348/E07.085

(57) ABSTRACT

An endoscopy system (1) comprises an endoscope (2) with a camera (3) at its tip. The endoscope extends through an endoscope guide (4) for guiding movement of the endoscope and for measurement of its movement as it enters the body. The guide (4) comprises a generally conical body (5) having a through passage (105) through which the endoscope (2) extends. A motion sensor comprises an optical transmitter (7) and a detector (8) mounted alongside the passage (105) to measure the insertion-withdrawal linear motion and also rotation of the endoscope by the endoscopist's hand. The system (1) also comprises a flexure controller (10) having wheels operated by the endoscopist. The camera (3), the motion sensor (7/8), and the flexure controller (10) are all connected to a processor (11) which feeds a display.

### FIELD OF THE INVENTION

The invention relates to endoscopy.

### PRIOR ART DISCUSSION

Endoscopy is a general-purpose investigative procedure in which a camera is inserted into the body to view the internal organs via natural orifices such as the GI tract.

Colon cancer is one of the biggest killers of people in the developed world; however, it is curable if caught early. Key to catching colon cancer early is to have a regular screening endoscopy. This is recommended every 5-10 years for all people over the age of 55. During endoscopy a flexible camera is inserted into the anus while the patient is lightly sedated and the clinician examines the lining of the colon (the lumen) for the presence of cancer or other pathologies.

Recent studies suggest that up to 10% of polyps >1 cm and 25%<6 mm can be missed with colonoscopy.

There are a number of challenges in endoscopy that can compromise the ability of the clinician to detect cancer:
Manoeuvring the endoscope is technically and physically challenging thereby distracting the clinician from concentrating on the visual image
Intestinal contents can obscure the view of the lumen
Inexperienced clinicians may be moving the camera too fast to accurately perceive pathologies
It is easy for a clinician to become disoriented and loose their sense of where they are in the intestines making it difficult to find lesions identified on a prior endoscopy

Images of the intestines may also be recorded by a camera in a swallowed capsule as it progresses through the intestines, as described in US2005/0192478 (Williams et al). These cameras record long videos for offline review by clinicians, and often they have periods of little change due to the capsule being stationary. Because of the length of these videos clinicians need software tools to focus their attention on clinically relevant parts of the videos, thereby increasing the efficiency of the inspection time. When a lesion is found in the video it can be difficult to locate exactly where it is within the intestines, making surgical follow-up difficult.

WO2008/024419 (STI Medical Systems LLC) describes a system for computer aided analysis of video data of an organ during an examination with an endoscope. Images are processed to perform functions such as removing glint and detecting blur. A diagnosing step involves reconstructing a still image.

WO2005/062253 describes a mechanism for automatic axial rotation correction for in vivo images.

Reference [5] describes processing of endoscopic image sequences for computation of camera motion and 3D reconstruction of a scene.

The invention is directed towards providing an improved endoscopic system.

### LITERATURE REFERENCES

[1] Good Features to Track, Jianbo Shi, Carlo Tomasi IEEE Conference on Computer Vision and Pattern Recognition (CVPR '94).
[2] Multiple view geometry in computer vision, Hartley and Zisserman, 2000.
[3] M. Pollefeys, 3D from Image Sequences: Calibration, Motion and Shape Recovery, Mathematical Models of Computer Vision: The Handbook, N. Paragios, Y. Chen, O. Faugeras, Springer, 2005.
[4] R. Eustice, M. Walter, and J. Leonard, Sparse Extended Information Filters: Insights into Sparsification, In Proceedings of the 2005 IEEE/RSJ International Conference on Intelligent Robots and Systems (IROS), Edmonton, Alberta, Canada, August 2005.
[5] T. Thormahlen, H. Broszio and P. N. Meier “Three-dimensional Endoscopy” Falk Symposium no. 124, Medical Imaging in Gastroenterology and Hepatology, Kluwer Academic Publishers, Hannover ISBN 0-7923-8774-0.
[6] David E. CRUNDALL and Geoffrey UNDERWOOD, “Effects of experience and processing demands on visual information acquisition in drivers”, ERGONOMICS, 1998, VOL. 41, No. 4, 448-458

### SUMMARY OF THE INVENTION

According to the invention, there is provided an endoscopy system comprising:
an endoscope having a camera;
an image processor for receiving endoscopic images from the camera and for processing the images;
a motion sensor adapted to measure linear motion of the endoscope through a patient orifice; and
a processor adapted to use results of image processing and motion measurements to generate an output indicative of a disease and of quality of the endoscopy procedure.

In one embodiment, the motion sensor comprises means for measuring extent of rotation of the endoscope, and the processor is adapted to use said motion data.

In another embodiment, the motion sensor comprises a light emitter and a light detector on a fixed body through which the endoscope passes.

In a further embodiment, the system comprises an endoscope tip flexure controller and the processor is adapted to receive and process endoscope tip flexure data and for correlating it with endoscope motion data and image processing results.

In one embodiment, the processor is adapted to perform visualisation quality assessment.

In another embodiment, the processor is adapted to perform visualisation quality assessment by automatically determining if visual display image rate is lower than a threshold required to adequately view a part of the lumen.

In a further embodiment, the processor is adapted to vary said threshold according to conditions.

In one embodiment, a condition is detection of salient features during image processing, said salient features being potentially indicative of a disease and the threshold is set at a level providing sufficient time to view the images from which the salient features were derived.

In another embodiment, the processor is adapted to determine from endoscope tip three dimensional and linear motion if the lumen has been adequately imaged.

In a further embodiment, the processor is adapted to execute a classifier to quantify visualisation quality.

In one embodiment, the classifier is a support vector machine.

In another embodiment, the processor is adapted to process eye tracking data and to associate this with motion of the endoscope to measure the ability of a clinician to perceive disease.

In a further embodiment, the eye-tracking data is stored as calibration data.

In one embodiment, the processor is adapted to generate an internal map of a patient's intestine using image processing results and motion measurements referenced against stored models.

In another embodiment, the processor is adapted to store images from which the map is derived, for traceability.

In a further embodiment, the processor is adapted to generate outputs arising from testing current measured motion and image processing results against a plurality of correlation requirements.

In one embodiment, a requirement is that the endoscope should not be pushed further through the patient's orifice when the image processing indicates that the endoscope is against a lumen wall.

In another embodiment, a condition is that a required set of endoscope linear and rotational movements are performed to flick the endoscope out of a loop, the loop being indicated by the image processing results.

In a further embodiment, the processor is adapted to generate a disease risk indication according to the image processing and to include disease location information with reference to an intestine map.

In one embodiment, the processor is adapted to apply a weight to each of a plurality of image-related factors to generate the output.

In another embodiment, the factors include focus, illumination, features, and image motion.

In a further embodiment, the processor is adapted to generate a display indicating meta data of high risk regions of the lumen.

In one embodiment, the processor is adapted to increase frame rate of a display where the disease risk is low.

In another embodiment, the system comprises a classifier such as a support vector machine to classify the risks of missing a lesion.

In a further embodiment, the processor is adapted to generate an indication of repetition of a procedure

In one embodiment, the processor is adapted to un-wrap a three-dimensional map into a two-dimensional map for display.

In another embodiment, the processor is adapted to represent in two dimensions areas of extreme shape change with contour lines in a manner similar to those used on maps.

In a further embodiment, the processor is adapted to extract a three-dimensional structure of a lumen is using sparse keypoint tracking based on visual simultaneous localization and mapping, and to detect key points in two-dimensional images.

### DETAILED DESCRIPTION OF THE INVENTION

### Brief Description of the Drawings

The invention will be more clearly understood from the following description of some embodiments thereof, given by way of example only with reference to the accompanying drawings in which:—

FIG. 1 is a diagram illustrating an endoscopy system of the invention;

FIG. 2 is a sample display, showing captured images and a plot of automatically-detected disease risk; and

FIG. 3 is a sample display in which high risk regions are highlighted in the display as shown by a play bar across the bottom;

FIG. 4 is a diagram illustrating operation of the system for live endoscopy; and

FIG. 5 is a diagram illustrating operation of the system using recorded video and inputs from a capsule sensor.

### DESCRIPTION OF THE EMBODIMENTS

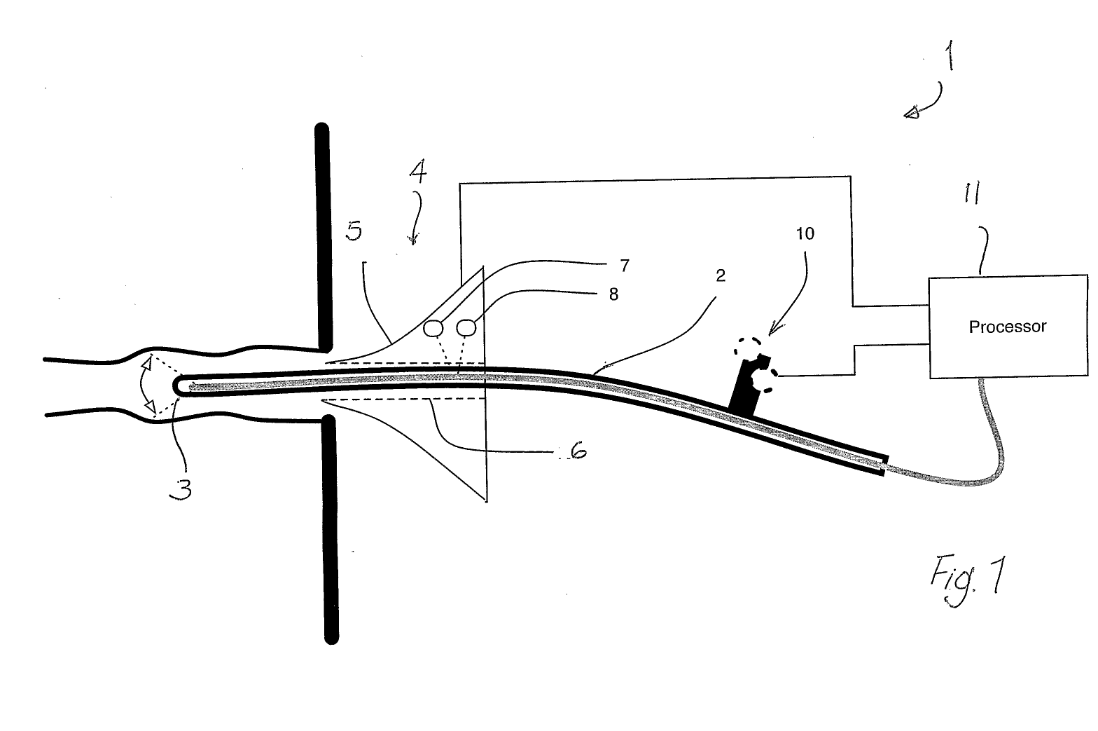

Referring to FIG. 1 an endoscopy system 1 comprises an endoscope 2 with a camera 3 at its tip. The endoscope extends through an endoscope guide 4 for guiding movement of the endoscope and for measurement of its movement as it enters the body. The guide 4 comprises a generally conical body 5 having a through passage 6 through which the endoscope 2 extends. A motion sensor comprises an optical transmitter 7 and a detector 8 mounted alongside the passage 6 to measure the insertion-withdrawal linear motion and also rotation of the endoscope by the endoscopist's hand. The sensor 7/8 is based on the optical mouse emitter/receiver principle such as the Agilent sensor ADNS-6010 or similar device. The system 1 also comprises a flexure controller 10 having wheels operated by the endoscopist. The camera 3, the motion sensor 7/8, and the flexure controller 10 are all connected to a processor 11 which feeds a display.

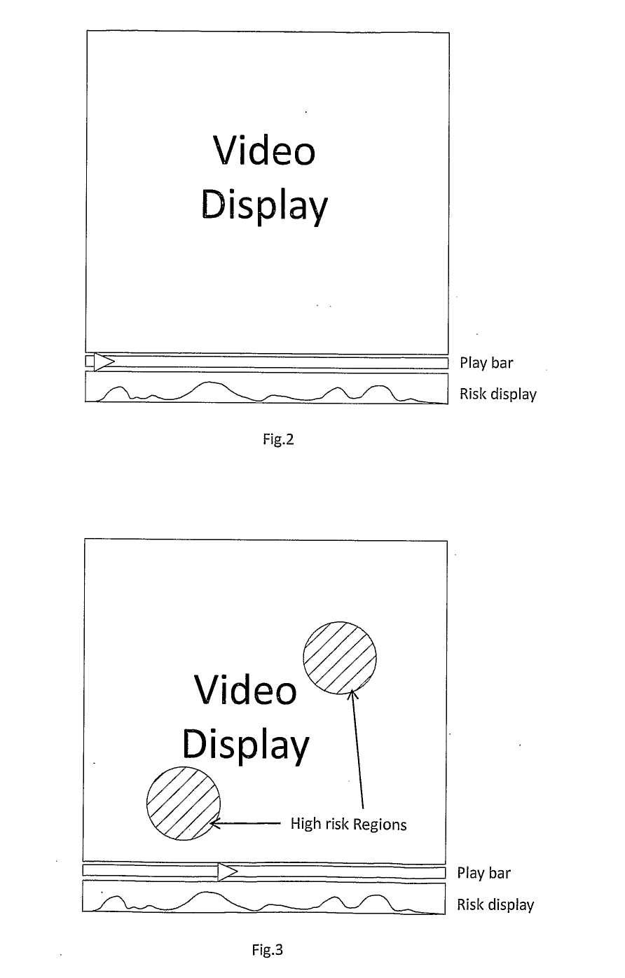

The processor 11 determines the extent of correlation of motion data provided by inputs from the sensor 7/8 and the flexure controller 10 with data concerning position and orientation of the endoscope tip derived from the camera images. This processing provides very comprehensive data in real time or recorded for playback later. For example a video sequence as shown in FIG. 2 may be presented with meta-data to indicate the high risk regions. The play bar along the bottom of this display indicates the time spent on the endoscopy so far. If the whole sequence is not to be visualized the clinician may skip forward to those high risk regions which are above a predetermined threshold. In FIG. 2 the risk assessment is applied to an image frame as a single entity. The risk assessment can also be applied to sub images with a view to identifying and visually highlighting the main source of risk within an image as shown in FIG. 3, in which the circles represent highlighting of parts of images automatically identified as being potentially diseased. This can be particularly important for training novice clinicians.

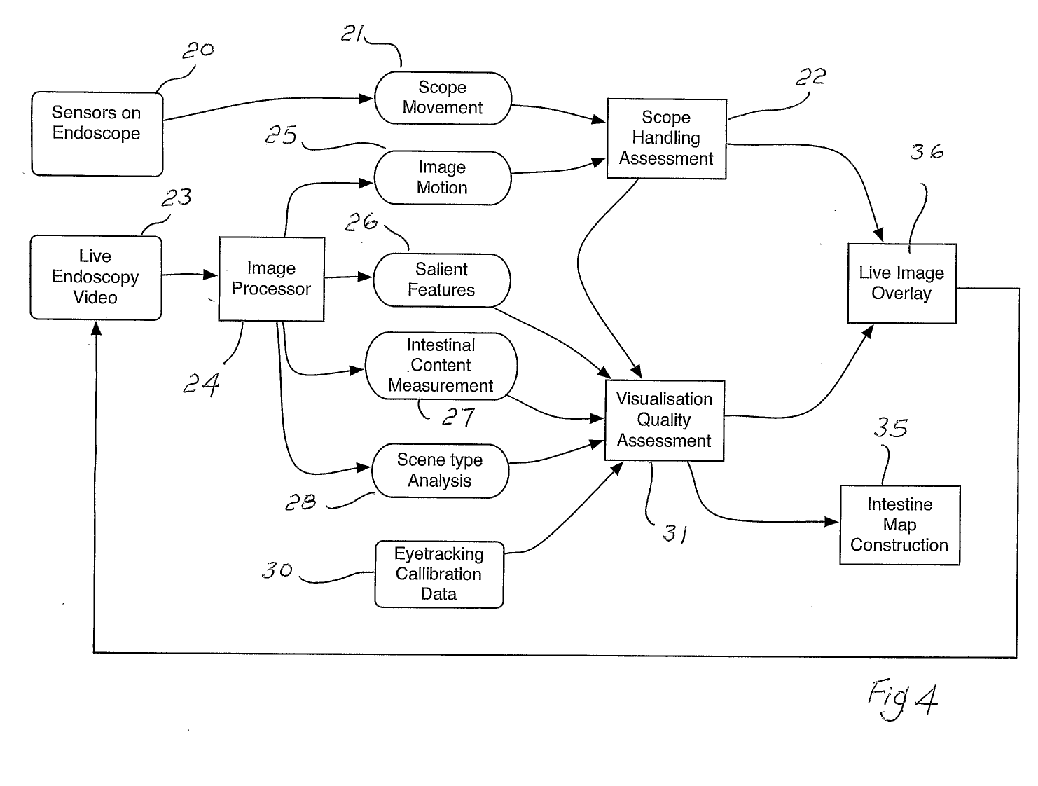

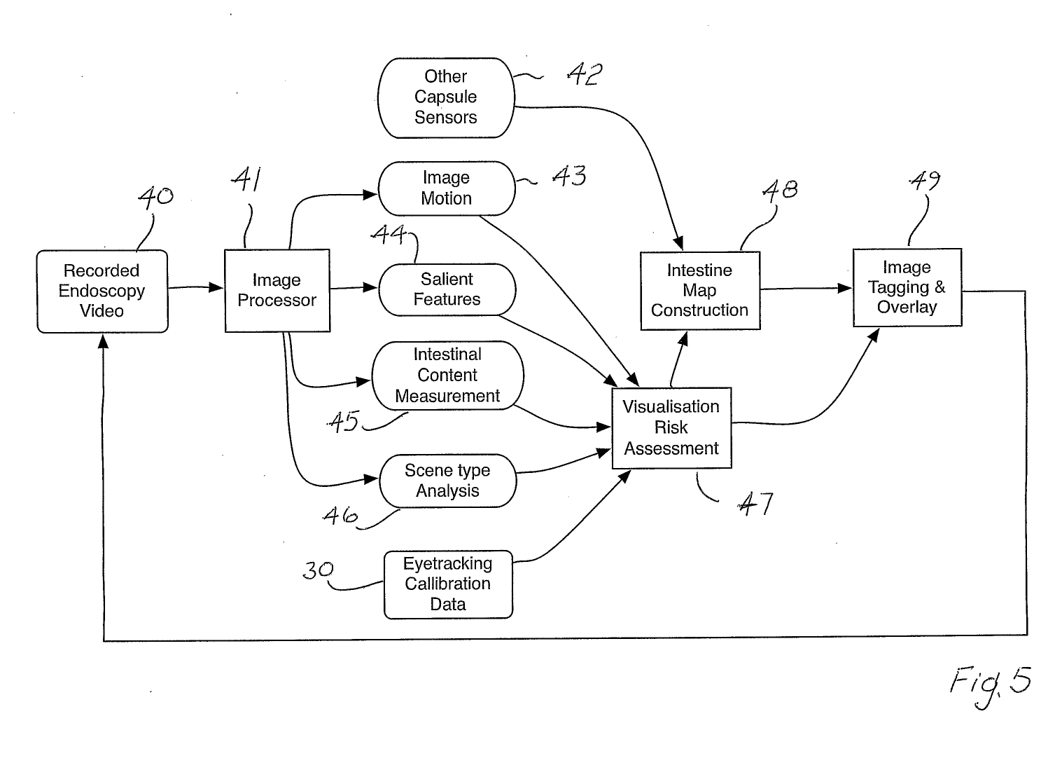

Referring to FIGS. 4 and 5 some functions executed by the processor 11 of the system are illustrated. In step 20 the motion sensors feed data indicating linear movement and rotation of the endoscope to a function which in step 21 processes scope movement, which in turn feeds a step 22 of scope handling assessment. The latter is very important as it uses the feeds from the sensor 7/8 and the flexure controller 10 to determine the extent to which the camera has been turned around to view the full extent of the colon including behind folds and chambers. By monitoring the extent of linear motion and mapping it to the degree of rotation and camera flexure the processor 11 can generate an output indicating the extent of the colon which has been adequately imaged. The processor 11 executes a classifier to generate this data. This information may be determined independently of image processing, and may subsequently be correlated with image motion 25 outputs to generate the scope handling assessment 22. Scope handling assessment may also be calculated from the scope movement information 21 alone.

In parallel, live endoscopy video images are fed in step 23 for image processing in step 24, and this in turn feeds an image motion step 25, a step 26 of determining salient features, a step 27 of performing intestinal content measurement, and a step 28 of performing scene type analysis. These functions are very important as they generate a considerable amount of useful information concerning the clinician's performance and condition of the colon. The salient features step 26 identifies by image processing image artifacts such as edges and shapes which are potentially indicative of lesions and anatomical landmarks. The steps 26, 27, and 28 feed into a visualisation quality assessment step 31, which also receives a feed from the scope handling assessment step 22.

Also in parallel eye-tracking calibration data, which measures the perceptual bandwidth of the individual endoscopist or a class of endoscopist is fed in step 30 to a step 31 of visualisation quality assessment. This calibration data may be as described in Reference [6]. The perceptual bandwidth is used to determine how many salient features that an endoscopist can accurately perceive within a given time frame. If the images containing salient features are moving faster than the endoscopist can perceive them then the risk of missing lesions is high and the endoscopist will be provided with a warning to slow down.

Step 31 feeds a step 35 of intestine map construction which creates and offline map of the colon for later review. Step 31 also feeds a live image overlay display step 36.

Step 31 is very advantageous as it processes with the benefit of both image processing results and physical motion measurement. A simple example is that the image processing step 26 may identify a salient feature which is potentially indicative of a lesion. However, if the scope handling assessment 22 indicates that the camera moved too quickly past the lesion then the time to view adequately may have been too short for the clinician and an alert is outputted. Another example is that the image processing indicates that the camera is up against the colon wall. A further example is where scope movement information 21 indicates that the scope 2 is being inserted and image motion 25 indicates that the head of the scope 2 is withdrawing. Such a negative correlation would indicate that the endoscope is looped. If the clinician is not making the sequence of endoscope movement required to “flick” out of the loop (combination of linear and rotation movement of the endoscope) then an alert can be raised, or fault logged if it is a training session. A simpler example is that an alert is raised if the motion sensor indicates that the endoscope is being pushed in without the camera having a clear field of view up the colon.

In another mode of operation, as illustrated in FIG. 5 in step 40 recorded endoscopy video images are fed to image processing 41. This in turn feeds the steps of image motion analysis 43, salient feature determination 44, intestinal content measurement 45, and scene type analysis 46. Eye-tracking calibration data is fed in step 30 to visualisation risk assessment 47, in turn feeding intestine map construction 48, in turn feeding image tagging and overlay 49.

The major difference between the modes of operation of FIGS. 4 and 5 is that in FIG. 5 the processing is performed off-line using recorded video. This illustrates versatility of the system.

In the mode of FIG. 4 the processing is in real time. Also, the FIG. 5 mode makes use of feeds from capsule sensors, however, this is not necessary.

Operation of the system as described above provides:
mapping of the intestines (step 35),
automatic detection of lesions (steps 26, 31),
correlating image motion recorded at the tip of the endoscope 2 to the motion of the endoscope recorded at the patient orifice by the sensor 7/8,
generating a display of video data in a 2D or 3D format (step 35, 36),
producing a quality assessment for the endoscopy based on the skill of the endoscopist's handling of the instrument and the quality of the visualization (step 31),
live overlay of decision support information on an endoscopy screen 9 step 36), and
tagging image sequences in recorded endoscopy data with information related to the potential for clinically relevant lesions (step 26).

The system achieves a quality control for endoscopy because of correlation of the measurement data provided by the motion sensor and the image processing. Thus, the system provides an objective assessment for the endoscopist handling skills, and it assesses the quality of the endoscopy based on how well the lumen was visualized. Further, the system warns the clinician when the risk of missing a cancer or lesion is high because of salient features which might not have been viewed correctly. Also the processor builds a map of the intestine in step 35 to help clinicians locate lesions within the intestines during follow-up procedures. This map is a representation of the surface of the colon and is made up of multiple polygonal surface patches. Each patch may be imaged multiple times during a video sequence. The map is made up of the best quality image of each patch (highest resolution and image quality). Patches are related to each other using estimates of image motion (25) and optionally data from the scope sensors (21). As the colon is a tube structure it is necessary to start again in order to inspect the entire surface of the colon. When portions of the colon have been missed some polygons remain unfilled, or filled with only low-resolution or blurred images. A visualisation quality assessment can be arrived at by estimating what proportion of the colon has been adequately visualised using the proportion of high quality polygons verses missed polygons and low quality polygons in the map.

Further, the system 1 allows for a safe acceleration of the clinical review of recorded videos of endoscopy by playing (step 40) the video at a speed appropriate to the risk of potential lesions and the automatic removal of frames that do not contain information, for example blurred frames.

The system accelerates the accurate visualization of recorded endoscope data by manipulating the speed of display based on the image contents. It marks up the location of endoscope images. Also, it warns clinicians about the risk of missing lesions based on an analysis of the movement of the endoscope. Also, it assesses the overall quality of an endoscopy based on the accumulated risk for an endoscopy normalized for the length of the endoscopy and quality of the preparation.

The classification decisions of the system are based on an analysis of the perceptual ability of the clinician as measured using eye tracking, namely the types of features in the images that clinicians associate with particular lesions. The number of salient visual features in the images is measured using a model of the human visual system. This information allied with a model of the human perceptual system gives a prediction of the time required to correctly visualize these salient features to determine if they are in fact lesions. The time that a lesion spends in view is directly related to the motion of the tip of the endoscope camera. The step 26 uses a model of the salient features of the colon to set a visualization time requirement—if this requirement is met or exceeded then the risk of missed lesions is low, however if the time requirement is not met then the risk of missed lesions is high.

The risk of a pathology being present in an image is related to the number and distribution of image features that indicate the presence of pathologies. In order for a human being to accurately perceive and categorize these indicative features the brain must have adequate time to process this information. If the image is moved too quickly then only partial analysis is performed and thus there is a risk that a clinically relevant pathology may be missed. The camera image may be poor (for example, occluded by intestinal contents or pushed into the wall of the colon). Thus, measurement of image contents is key to any assessment of screening quality.

The risk of a pathology being missed is a function of a number of factors: the quality of the image in terms of aspects such as lighting and focus, the number and distribution of image features that are indicative of pathologies, and the speed of movement of the camera. The processor 11 analyses the endoscopy images to estimate this risk of missing pathologies by combining each of the relevant risk factors into an overall risk estimate.

The algorithm for combining the risk factors can be represented simply as:

Rₘᵢₛₛ=w₁ƒ(focus)+w₂ƒ(illumination)+w₃ƒ(features)+w₄ƒ(image motion)

Where Rₘᵢₛₛ is the risk of missing a lesion and the weights w₁-w₄ and the functions f( ) are determined after calibration for specific procedures and the standards that a particular clinic many apply.

The risk Rₘᵢₛₛ may also be estimated using a supervised machine learning approach where experts label video sequences according to the perceived risk. The labelled sequences are then used to train a classifier in this embodiment a support vector machine. The classifier can then provide a risk assessment based on a classification of the input images. The risk Rₘᵢₛₛ may also be determined as a combination of such classifiers for each of the risk factors individually.

The risk measure is then used to enable a number of intelligent user interfaces that aim to improve the performance of screening endoscopies.

Referring again to FIG. 5, in the case where recordings of endoscopies have been made from devices such as capsule endoscopy, virtual endoscopy or from recordings of conventional push endoscopy the clinician is asked to review extended sequences of video. In order to accelerate this process without compromising the clinical review of this data the video sequence is displayed at a speed parameterized by the risk of missing a lesion: i.e. where this risk is low the frame rate of display is accelerated to facilitate very rapid review and where the risk is higher the frame rate is reduced to a speed consistent with good visualization of the lumen. The actual speed of display can also be parameterized by the expertise of the clinician. This can be determined empirically by having the clinician undergo perceptual performance testing or may be set based on the number of procedures that the clinician has performed. In addition to speed control, a video sequence may be presented with meta-data to indicate the high risk regions (as shown in FIGS. 2 and 3).

If the whole sequence is not to be visualized the clinician may skip forward to those high risk regions which are above a predetermined threshold.

In FIG. 2 above the risk assessment is applied to an image frame as a single entity. The risk assessment can also be applied to sub images with a view to identifying the main source of risk within an image as shown in FIG. 3. This can be particularly important for training novice clinicians.

An alternative application of the risk assessment protocol is to provide the clinician with visual and or audio feedback that their endoscopy is exhibiting characteristics that are classified as high risk. This would indicate that the endoscope 2 is moving too fast or that the lumen is not being adequately visualized. This proximal feedback would be particularly useful for trainees, however it may be also useful for clinicians to maintain standards in high-pressure endoscopy suites. The quality measure may be used to provide an indication about when the patient needs to return for a repeated scoping.

The processor 11 may generate a summative assessment at the end of an endoscopy (either live or recorded) with a view to providing endoscopists with an objective score for the quality of an endoscopy. Such assessments would have to be normalized for the overall length of the endoscopy and the quality of the patient preparation i.e. the amount of intestinal contents obscuring the view of the endoscopists.

### 2D and 3D Image Map to Improve Visualization of Endoscopy Data.

The processor 11 presents the data in such a way as to assist visualization. The video sequence is analyzed to extract its 3D structure; this structure is then overlaid with the 2D image data for each patch on the surface of the colon. Thus a sequence of video representing a part of the colon can be reduced to a single 2D patch projected onto the 3D model of the colon. Thus, endoscopy data is used to create a patient-specific model of the colon. This patient-specific model can then be used by the clinician to explore the colon in two ways:
The 3D model can be explored in a manner similar to conventional endoscopy where the camera navigates the colon. In fact the model colon could be placed into a colonoscopy simulator to create a natural interface for the clinician.
The processor 11 un-wraps the 3D model into a 2D sheet to facilitate rapid scanning. The 2D image patches are chosen as the best visualization of that section of the colon and provide an index into the video database referring to all of the video clips which have visualized this portion of the lumen.

In the case of 2D representations areas of extreme shape change could be represented with contour lines in a manner similar to those used on maps. The aim of this representation is to prevent significant distortion of the images in the resulting 2D representation. And to ensure full visualization of the colon as the representation would indicate if regions have been missed.

As the clinician explores the resulting visualization model (either 2D or 3D) a link is maintained by the processor 11 to the original video footage, thus if the clinician sees a potential lesion on the model a single click could bring up the source video of the endoscope that was used to create this section of the model. In addition, the visualization models could be used to reference other modes of medical imagery such as MRI or CT. The clinician could then compare, video, MRI, CT or other sources of data for this point in the anatomy.

The technical challenges in modelling a flexible and movable object such as the intestines are significant, however there are gross and fine landmarks available. The colon for example consists of a long tube divided into chambers by haustral folds. The haustral folds represent a significant landmark in the images. With each chamber the pattern of blood vessels form a unique pattern that can be used to track camera motion within the chamber of the colon. The 3D structure of the intestine is extracted using sparse keypoint tracking based on visual simultaneous localization and mapping approach used in robotics. Key points can be detected in the 2D images using key-point detection methods such as the Shi and Tomasi detector [1]. Specularities due to the reflection of the light on the wall of the colon are removed as they generate errors in matching but can also be used to give an estimate for the surface normal of a patch of the image. Features in each image are matched based on the similarity of small patches around each key point. With the set of matches RANSAC can be used to solve for the Fundamental Matrix [2]. This describes the relative position of the two camera views and thus a dense 3D surface estimation can be performed using a flexible pixel patch-to-pixel patch matching along epi-polar lines [3], the flexibility is necessary to allow for the deformation of the colon surface, with typical deformations limited to changes of scale and affine warp as rotations are uncommon.

3D views are combined iteratively using a sparse key-point matching to form a non-rigid 3D map To avoid localization error growing without bound overlapping sub-maps of colon sections are generated [4]. Within the sub-maps the positions of the keypoints are allowed to move to accommodate the flexible nature of the colon. The haustral fold landmarks can also be used to identify the reference location in other medical images such as MRI and CT.

Additional information may be used within the computational framework to reduce the ambiguity of the data. Movement data from sensors instrumenting the wheels of the endoscope or a sensor at the orifice of the body can be used to provide additional constraints for the 3D image data as can gyroscopes with a pill camera or the tip of the endoscope may be used to provide an additional estimate of camera position.

The invention is not limited to the embodiments described but may be varied in construction and detail.

1. An endoscopy system comprising:
an endoscope having a camera;
an image processor for receiving endoscopic images from the camera and for processing the images;
a motion sensor adapted to measure linear motion of the endoscope through a patient orifice; and
a processor adapted to use results of image processing and motion measurements to generate an output indicative of a disease and of quality of the endoscopy procedure.
wherein the processor is adapted to:
generate outputs arising from testing current measured motion and image processing results against a plurality of correlation requirements, perform a quality control for endoscopy because of correlation of motion sensor measurement data and image processing data, and generating an output including an objective assessment of the endoscopist handling skills and an assessment of quality of the endoscopy based on how well the lumen was visualized, and to generate an alert if it determines that the camera has moved too quickly to adequately view a part of the lumen.

2. The system as claimed in claim 1, wherein the motion sensor comprises means for measuring extent of rotation of the endoscope, and the processor is adapted to use said motion data.

3. The system as claimed in either of claim 1, wherein the motion sensor comprises a light emitter and a light detector on a fixed body through which the endoscope passes.

4. The system as claimed in claim 1, wherein the system comprises an endoscope tip flexure controller and the processor is adapted to receive and process endoscope tip flexure data and for correlating it with endoscope motion data and image processing results.

5. The system as claimed in claim 1, wherein the processor is adapted to perform visualisation quality assessment.

6. The system as claimed in claim 1, wherein the processor is adapted to perform visualisation quality assessment by automatically determining if visual display image rate is lower than a threshold required to adequately view a part of the lumen.

7. The system as claimed in claim 1, wherein the processor is adapted to perform visualisation quality assessment by automatically determining if visual display image rate is lower than a threshold required to adequately view a part of the lumen, and wherein the processor is adapted to vary said threshold according to conditions.

8. The system as claimed in claim 1, wherein the processor is adapted to perform visualisation quality assessment by automatically determining if visual display image rate is lower than a threshold required to adequately view a part of the lumen, and wherein the processor is adapted to vary said threshold according to conditions; and wherein a condition is detection of salient features during image processing, said salient features being potentially indicative of a disease and the threshold is set at a level providing sufficient time to view the images from which the salient features were derived.

9. The system as claimed in claim 1, wherein the processor is adapted to perform visualisation quality assessment by automatically determining if visual display image rate is lower than a threshold required to adequately view a part of the lumen; and wherein the processor is adapted to determine from endoscope tip three dimensional and linear motion if the lumen has been adequately imaged.

10. The system as claimed in claim 1, wherein the processor is adapted to perform visualisation quality assessment; and wherein the processor is adapted to execute a classifier to quantify visualisation quality.

11. The system as claimed in claim 1, wherein the processor is adapted to perform visualisation quality assessment; and wherein the processor is adapted to execute a classifier to quantify visualisation quality; and wherein the classifier is a support vector machine.

12. The system as claimed in claim 1, wherein the processor is adapted to perform visualisation quality assessment; and wherein the processor is adapted to process eye tracking data and to associate this with motion of the endoscope to measure the ability of a clinician to perceive disease.

13. The system as claimed in claim 1, wherein the processor is adapted to perform visualisation quality assessment; and wherein the processor is adapted to process eye tracking data and to associate this with motion of the endoscope to measure the ability of a clinician to perceive disease; and wherein the eye-tracking data is stored as calibration data.

14. The system as claimed in claim 1, wherein the processor is adapted to generate an internal map of a patient's intestine using image processing results and motion measurements referenced against stored models.

15. The system as claimed in claim 1, wherein the processor is adapted to generate an internal map of a patient's intestine using image processing results and motion measurements referenced against stored models; and wherein the processor is adapted to store images from which the map is derived, for traceability.

16. (canceled)

17. The system as claimed in claim 1, wherein a requirement is that the endoscope should not be pushed further through the patient's orifice when the image processing indicates that the endoscope is against a lumen wall.

18. The system as claimed in claim 1, wherein a requirement is that a required set of endoscope linear and rotational movements are performed to flick the endoscope out of a loop, the loop being indicated by the image processing results.

19. The system as claimed in claim 1, wherein the processor is adapted to generate a disease risk indication according to the image processing and to include disease location information with reference to an intestine map.

20. The system as claimed in claim 1, wherein the processor is adapted to apply a weight to each of a plurality of image-related factors to generate the output.

21. The system as claimed in claim 1, wherein the processor is adapted to generate a disease risk indication according to the image processing and to include disease location information with reference to an intestine map; and wherein the factors include focus, illumination, features, and image motion.

22. The system as claimed in claim 1, wherein the processor is adapted to generate a display indicating meta data of high risk regions of the lumen.

23. The system as claimed in claim 1, wherein the processor is adapted to increase frame rate of a display where the disease risk is low.

24. The system as claimed in claim 1, wherein the system comprises a classifier such as a support vector machine to classify the risks of missing a lesion.

25. The system as claimed in claim 1, wherein the processor is adapted to generate an indication of repetition of a procedure

26. The system as claimed in claim 1, wherein the processor is adapted to un-wrap a three-dimensional map into a two-dimensional map for display.

27. The system as claimed in claim 1, wherein the processor is adapted to un-wrap a three-dimensional map into a two-dimensional map for display; and wherein the processor is adapted to represent in two dimensions areas of extreme shape change with contour lines in a manner similar to those used on maps.

28. The system as claimed in claim 1, wherein the processor is adapted to un-wrap a three-dimensional map into a two-dimensional map for display; and wherein the processor is adapted to represent in two dimensions areas of extreme shape change with contour lines in a manner similar to those used on maps; and wherein the processor is adapted to extract a three-dimensional structure of a lumen is using sparse keypoint tracking based on visual simultaneous localization and mapping, and to detect key points in two-dimensional images.
